(19) United States
(12) Patent Application Publication
(10) Pub. No.: US 2007/0265934 A1
(43) Pub. Date: Nov. 15, 2007

(54) METHOD IN SUPPORT OF PRE-COMMERCE DECISION MAKING AND AUTOMATED PRODUCT LISTING GENERATION

(75) Inventors: Eric Hassman, San Francisco, CA (US); Frederick Charles Fiechter, Stateline, NV (US); Calbert Lai, Mountain View, CA (US); Jackson Robie Hull, San Francisco, CA (US); Daniel Sheppard, Brea, CA (US)

Correspondence Address: DARBY & DARBY P.C., P.O. BOX 770, Church Street Station, New York, NY, 10008-0770, US

(73) Assignee: Sitoa Corporation, San Mateo, CA (US)

(21) Appl. No.: 11/742,523

(22) Filed: Apr. 30, 2007

Related U.S. Application Data
(63) Continuation-in-part of application No. 11/497,958, filed on Aug. 1, 2006.
(60) Provisional application No. 60/707,810, filed on Aug. 11, 2005.

(51) Int. Cl. G06Q 30/00

(52) U.S. Cl. 705/26

(57) ABSTRACT

Pre-commerce decision making support that generates a product listing of an item for sale. An electronic catalog is received from a supplier containing an item to be offered for sale at a predetermined supplier price. A price markup is determined for the item based on markup-criteria, which is then utilized to compute a resale price for the item. The product listing is then generated offering the item for sale at the resale price. Additional product information concerning the item can be received from a third-party source and integrated into the product listing. The generated product listing can be published to a retailer as an interactive product listing for inclusion by a retailer in an inventory-less product offering, and can be customized, automatically, for each retailer using its markup criteria.

This claims priority under 35 U.S.C. §120 as a continuation-in-part application of U.S. patent application Ser. No. 11/497,958, entitled “Inventory-less Distribution,” filed Aug. 1, 2006, which claims priority pursuant to 35 U.S.C. §119 from Provisional Patent Application Ser. No. 60/707,810, entitled “Method and System For E-Commerce Between Suppliers and Merchants,” filed Aug. 11, 2005. The entire disclosure of each of the aforementioned priority applications are hereby incorporated by reference.

### FIELD OF THE INVENTION

The present invention relates to a method of facilitating the pre-commerce decisions made in generating of a product listing and, more particularly, is directed to a method of automating the decision making and generation of a product listing for products which are not kept in inventory.

### BACKGROUND OF THE INVENTION

The Internet and other distributed networks have provided a new and significant channel for conducting business transactions including the sale of merchandise. Typically, a customer visits a website of a particular outlet or web-retailer and browses an offering of products on the outlet's website. The customer can then select a specific item and purchase the item through a web interface. Many websites inform the customer if the item is in stock prior to completing the purchase transaction. After the item is purchased, the web-retailer transmits the order to its warehouse, where the item is picked, packed and shipped to the customer.

Variations on the traditional web-retailer/customer model have been created as the Internet has matured. Some web-retailers are merely the online presence of a traditional brick-and-mortar store. Thus, when the web-retailer receives an order, it can transmit the order to a brick-and-mortar store associated with the web-retailer because the brick-and-mortar store has the item in stock, or is geographically closest to the customer, or on some other basis. The brick-and-mortar store will either ship the ordered item to the customer, or allow the customer to collect the item at the selected or designated brick-and-mortar store.

Some websites facilitate transactions between customers and suppliers. For example, retailer or supplier aggregation web sites enable a customer to browse the products being offered by many different suppliers. The customer selects a specific product from a specific retailer through the aggregator website and purchases the item. The purchase typically occurs through the aggregator website. Alternatively, the aggregator can refer the customer to the retailer's website, where the transaction is completed.

Web-retailers also sell items for which they do not have inventory, but rather have arrangements with other suppliers. Thus, when a customer purchases an item which the web-retailer does not maintain in inventory, the web-retailer transmits the order to a supplier who then ships the item directly to the customer. The customer receives the item as though it was purchased from the supplier and not the web-retailer from which the customer expected shipment. In this manner the web-retailer acts similarly to a retail aggregator except that the customer is not necessarily aware that the order will be fulfilled by a third party, but rather becomes aware of the third-party supplier when the package is received.

Web-retailers are typically further burdened by other sales logistics, including the process of arranging and maintaining product listings and the pricing each item offered for sale. Product listings are typically web-pages which provide some information concerning the item and the price at which the item is being sold. The information provided in the listing is either provided directly by the supplier of the product or manually gathered and input by an employee of the web-retailer.

The price of each item offered by a web-retailed includes a mark-up which must be calculated. Each company or middle-man involved in a commercial transaction adds its mark-up to the price. Thus, the price of each item must be recalculated multiple times before it is listed and each party involved in the transaction must have the capacity and capability to perform the mark-up calculations.

There is a need for automating and outsourcing the pre-commerce services which are required in the retail and business-to-business sector. These services include the creation and management of product listings as well as automating the incorporation of information concerning the item into the product listing when the information is provided by a non-party to the transaction. Pre-commerce services can further provide a reduction of the redundancy of pricing and mark-up calculations.

### SUMMARY OF THE INVENTION

In accordance with one aspect of the present invention, a method in support of pre-commerce decision making for generating a product listing which offers an item for sale is provided. An electronic catalog is received from a supplier containing an item to be offered for sale at a predetermined supplier price. A price markup is determined for the item based on a markup-criteria. The price markup is then utilized to compute a resale price for the item that includes the supplier-price plus the price markup. The product listing is then generated offering the item for sale at the resale price.

In accordance with a further aspect of the present invention, product information concerning the item can be received from another source. The descriptive information can thereafter be extracted and integrated into the product listing.

In yet a further aspect, a generated product listing can be used to offer the item for sale and support the inventory-less fulfillment of resulting purchase transactions. The generated product listing can be published to a retailer as an interactive product listing. An order for the item included in the interactive listing is received in response to a purchase by the customer at the retailer. The retailer can then be charged the resale price for the item. The item is purchased from the supplier at the supplier-cost. The address of the purchasing customer is obtained, and the supplier instructed to ship the product to the address of the customer.

These and further aspects, features and advantages of the present invention will become more apparent from the following detailed description when taken in connection with the accompanying drawings which show, for purposes of illustration only, a preferred embodiment of the present invention.

### BRIEF DESCRIPTION OF THE DRAWINGS

FIG. 1 illustrates an embodiment of a communication network that connects customers, outlets, providers, and suppliers;

FIG. 2 depicts a flow diagram illustrating steps of a process in accordance with an embodiment of the present invention;

FIG. 3 depicts a flow diagram illustrating a communication between the customer and the supplier going through the provider;

FIG. 4 depicts a flow messaging diagram in accordance with an embodiment of the present invention; and

FIG. 5 depicts a flow diagram illustrating steps of a process in accordance with a further embodiment of the present invention.

### DETAILED DESCRIPTION OF CERTAIN PREFERRED EMBODIMENTS

By way of overview and introduction, the present invention provides a method in support of an e-commerce transaction involving a customer, an outlet, a provider, and a supplier. The outlet can include a web-based retailer, a web-presence of a brick-and-mortar store, an auction site, or any retailer selling goods over a distributed network. In the particular e-commerce transaction supported by this invention, the outlet does not maintain all the goods sold through its web-based store in inventory. Rather, the supplier holds particular goods in inventory.

The provider facilitates the coordination and communication between the supplier and the outlet, and further facilitates the delivery of goods from the supplier to the customer. In particular, the provider maintains a list, or database, of items that are available from suppliers, and preferably approved or pre-selected suppliers. The list of available items is provided to the outlets by the provider for a price determined by the provider. The outlet can select items from the provider's list that the outlet wants to include in its product offering on its website.

Optionally, the provider can receive a catalog of available items from the supplier, preferably in electronic form. The provider can then analyze the available items and determine which ones to offer the outlet for inclusion in its product offering. Furthermore, the provider can determine the desired mark-up price for each item to establish a resale price. This resale price and associated item are then used to generate the interactive product listing which is published to the outlet. If desired additional information concerning the item can be retrieved from various third-party sources and integrated into the product listing.

When a customer selects one of the items not held in inventory by the outlet, the outlet transmits a purchase order to the provider for the selected item. Preferably, the purchase order transmitted to the provider includes details regarding the transaction between the customer and the outlet. The provider then transmits its own (“a second”) purchase order for the selected item to a supplier and waits for an acceptance to be communicated from the supplier that the second purchase order has been accepted. Once the provider receives acceptance of the second purchase order, the provider accepts the first purchase order.

In a more particular feature of the present invention, the transaction details of the first purchase order include a shipping address of the customer. The transaction details are communicated from the provider to the supplier accepting the purchase order. Additionally, the provider further advises the supplier of the branding requirements of the outlet from which the first purchase order originated. The supplier fulfills the e-commerce transaction between outlet and the customer by shipping the product directly to the particular customer in accordance with the branding requirements of the outlet.

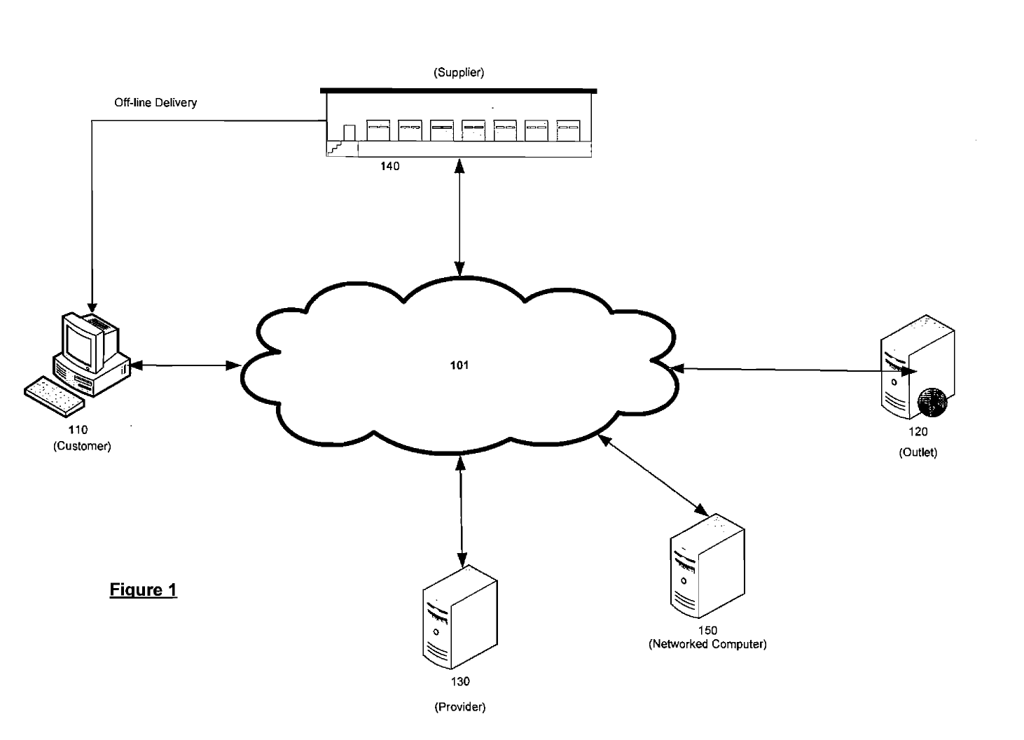

FIG. 1 illustrates an embodiment of a communication network 101 in which customers 110 at computer terminals are shown connected to an outlet 120 (e.g., web-retailer). The outlet 120 communicates with a provider 130 that facilitates the e-commerce transaction between the customer 110 and the outlet 120. The provider 130 communicates with supplier 140 to fulfill the purchase transaction for the outlet 120.

While FIG. 1 illustrates all parties to be in communication over the same distributed network 101, such as the Internet, it should be understood that the communication required by the present invention can take place over multiple and/or disjoint networks provided that the customer 110 and outlet 120 can communicate with each other, the outlet 120 and the provider 130 can communicate with each other and the provider 130 and the supplier 140 can communicate with each other. For example, the customer 110 can communicate with the outlet 120 over the Internet through the outlet's web-based store front. Alternatively, the customer 110 can communicate with the outlet 120 through a terminal located within the brick-and-mortar presence. Similarly, the outlet 120 can communicate with the provider 130, and the provider 130 with the supplier 140, over the Internet or an alternative network connection (e.g. telephone-based data link).

Because the Internet is relatively seamless, various other networked computers 150 (e.g., businesses, web services, schools, etc.) can also communicate over the network 101 with any of the customer 110, outlet 120 provider 130, and supplier 140. A customer 110 can use the services provided by the networked computer 150 to comparison shop or research the product being offered. Additionally, network computers 150 can include credit card processing services utilized by the outlet, provider 120, and supplier 140.

FIG. 1 illustrates all parties in communication via a distributed computer network 101. However, in a further detail of the present invention, not all communications of the present invention are required to be transmitted via the distributed computer network 101. For example, the provider 130 can communicate with the supplier 140 by facsimile or via telephone. Certain known advantages of speed and reliability are realized by electronic communication over a network 101. However, not all messages are required to be sent in this manner.

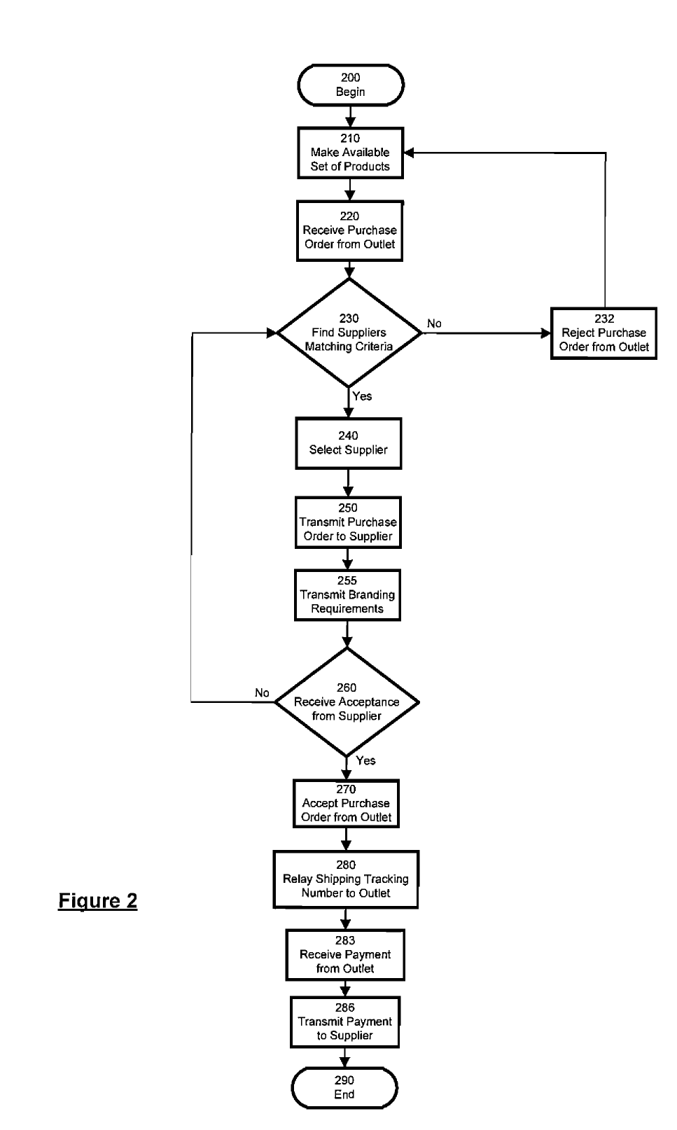

FIG. 2 depicts a flow diagram illustrating steps of a process by which the provider 130 facilitates an e-commerce transaction in accordance with an embodiment of the present invention. Beginning at step 210, the provider 130 makes available a set of products that can be selected and included by the outlet 120 as part of a product offering on the outlet's website. At step 220, the provider 130 receives a purchase order from an outlet 120. Typically the purchase order is transmitted by the outlet 120 in response to an order being placed by a customer 110 at the outlet's website in the course of an e-commerce transaction process flow which, to the customer, can be conventional while still being implemented at the backend in accordance with this invention.

The provider 130 searches its records, preferably stored in a database, for one or more suppliers 140 that match predetermined criteria. The matching process is preferably performed utilizing a rule-based engine. The rules utilized can be varied depending factors such as the outlet 120 from whom the purchase order is received, the product specified in the purchase order, and any relationships established between any of the outlet 120, the provider 130, and the supplier 140. The determination of a match can include an analysis of various factors associated with each prospective supplier 140 including inventory of the product, a price constraint, a profit margin constraint, a geographic constraint, a contractual constraint, or a combination thereof. The constraints can include optimizing certain factors such as profits, price, geographical distances, and volume of sales through either the outlet 120 or the supplier 140.

If the provider 130 can not find a supplier 140 satisfying the required criteria at step 230, then the provider 130 can reject the purchase order from the outlet 120 at step 230. In a further aspect of this invention, the provider 130 rarely proceeds to step 232 to reject the purchase order, because inventory updates from the suppliers 140 are distributed by the suppliers 140 to the provider 130, and relayed by the provider 130 to the participating outlets 120. Specifically, each supplier 140 can send updates of current inventory of specific products to the provider 130, which are then aggregated by product and selectively distributed to the outlets 120. The outlets 120 can use the inventory information to notify potential customers 110 if the item is in stock. In this manner, outlets 120 can reject orders from customers 110 at the outlet's website without necessitating communication with the provider 130 or supplier 140. Further, outlet 120 can utilize information provided by provider 130 to control its web or other commercial interface to not offer a product that is not presently in supply.

In a more detailed aspect, the provider 130 can aggregate product inventory data from suppliers 140 in accordance with rules or criteria that are specific to each outlet 120, supplier 140, or provider 130. For example, when the provider 130 is computing the inventory count to provide to a particular outlet 120, if the price of a specific product from a supplier 140 would not produce a sufficient profit for either a specific outlet 120 or the provider 130, then the inventory from that supplier 140 can be excluded from the inventory count provided to the particular outlet 120. In a further example, suppliers 140 can exclude outlets 120, and vice-versa because of a competitive relationship or prior unsatisfactory transactions. The provider 130 can further provide a numerical inventory count to the outlet 120 or simply an in-stock or out-of-stock indication.

If the provider 130 successfully determines one or more suppliers 140 matching the specified criteria, the provider 130 selects a supplier 140 at step 240. The selection can be performed randomly. Preferably, however, step 240 is performed using the same rules or additional rules utilized in step 230. For example, from the list of suppliers, a preferred supplier 140 can be selected. Alternatively, the supplier 140 can be selected to maximize profits for the provider 130 or the outlet 120.

Once the supplier 140 is selected at 240, a second purchase order is created and transmitted to the selected supplier 140. This purchase order is dependent upon the existence of the initial order by the customer, and is created in connection with the inventory-less transaction processing of the present invention. Preferably, this purchase order contains specific information regarding the transaction including the shipping address of the particular customer 110, and the item purchased. Optionally, the information provided in the purchase order to the supplier 140 can include information regarding the outlet 120 from which the e-commerce transaction was initiated. The outlet information can include a simple identification of the outlet 120 or detailed branding requirements of the outlet 120. Based on either the outlet identification and branding requirements, the supplier 140 can generate and ship the purchased item directly to the customer 110 in a manner that conforms to the branding requirements of the particular outlet 120. For example, the shipping method, shipping label, and packing slip can all reflect the name, logo, and preferences of a particular outlet 120.

The outlet information can be provided in the purchase order to the supplier 140, or as a separate communication in process 200. However, the outlet information, including the branding requirements, can be communicated outside of process 200. Preferably, the branding information provided is in the form of printable data. For example, the provider 130 can simply provide printable images to the supplier 140 who can then print and use as the shipping label, packing slip, and receipt. Alternatively, the provider 130 can transmit data concerning the transaction that is sufficient to fill in a template associated with the specific outlet 120. The templates can be transmitted to the supplier 140 in-process or out-of-process, and can be maintained in a database local to the supplier 140 for future use or reference. Additionally, the provider 130 can supply the supplier 140 with an application or plug-in program capable of receiving the transmitted transaction data that defines or describes the branded labels, receipts, packaging, or other branded forms.

After the provider 130 transmits the second purchase order to the supplier 140, the provider 130 can wait to receive acceptance of the purchase order from the supplier 140 at step 260. Awaiting acceptance can be performed by monitoring transmissions on a computer network, or other distributed network. Waiting for acceptance from the supplier 140 ensures that the supplier 140 has sufficient inventory, in case the supplier 140 has not notified the provider 130 of a recent change in inventory.

If the supplier 140 does not receive acceptance for the purchase order from the supplier 140 within a prescribed period of time, the provider 130 can return to step 230, where the rejecting supplier 140 is eliminated from the list of possible suppliers 140 for this transaction, and the provider 130 again searches for suppliers 140 matching specific criteria. Alternatively, the provider 130 can return to step 240 and select the next best supplier 140 from the list of previously identified suppliers 140. However, performing the search 230 across all suppliers 140 ensures the most recent inventory counts, prices, and other factors are accounted for in selecting a supplier 140.

If the supplier 140 accepts the purchase order from the provider 130, the provider 130 can accept the order from the outlet 120 at step 270. The provider 130 can accept the purchase order from the outlet 120 at any point after receiving it. Thus, in the absence of an acceptance from a supplier or in lieu of seeking acceptance, the provider 130 can assess the risk of non-fulfillment and proceed to step 270. However, it is preferable that the provider 130 delay accepting the purchase order from the outlet 120 until the provider 130 has determined that the supplier 140 has agreed to fulfill the order.

Once provided with the product ID, the customer shipping address, and the branding requirements of the outlet 120, the supplier 140 can ship the item directly to the customer 110. From the customer's point of view, the shipment will appear as though it came directly from the outlet 120. The packaging, shipping label, invoice, and packing slip can all appear to the customer to have been provided and generated by the outlet 120. The customer 110 can complete the transaction and receive the desired product without knowledge that the outlet 120 never held the product in stock, without knowledge that supplier 140 sourced the item, and without knowledge of the provider's role in the transaction.

Once the supplier 140 has shipped the product or generated a shipping label for the product, the shipping tracking number can be communicated to the outlet 120, directly from the supplier or indirectly by way of the provider 130, at step 280.

Payment between the parties can also be coordinated by the provider 130. Preferably, the outlet 120 transmits payment for the purchase order after the provider 130 has accepted the outlet's purchase order at step 270, and more preferably after receiving the relayed tracking number at step 280. Thus, at step 283, the provider 130 will receive payment from the outlet 120, and, now that the provider 130 has the funds from the outlet 120 and has confirmed the shipment of the product through receipt of the tracking number, the provider 130 can transmit payment to the supplier 140 at step 286. Payment between the parties can occur at varying points throughout the process 200. However, delaying payment until steps 283 and 286 prevents each party from transmitting monies not yet received from the adjacent party upstream in the transaction and delays the outlay of monies until the outlet 120 and the provider 130 are sufficiently satisfied that the transaction is complete and that the customer 110 will receive the desired product.

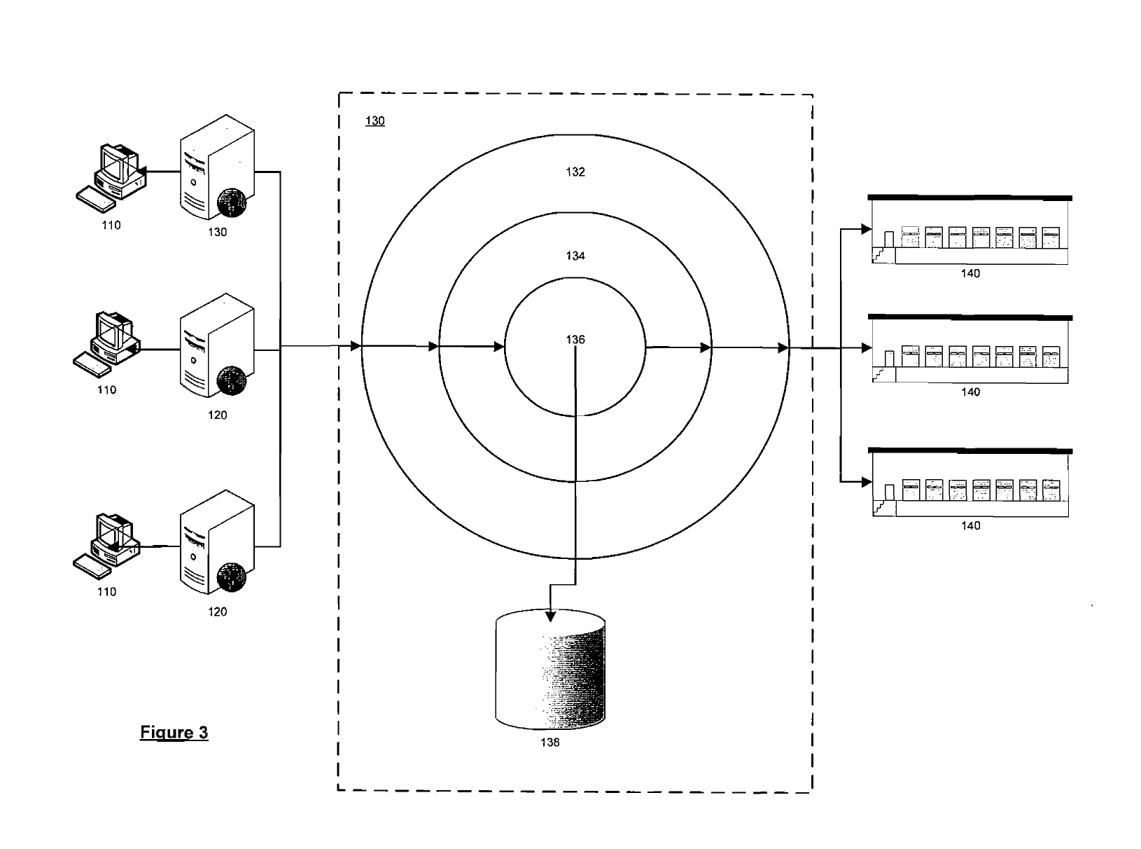

FIG. 3 depicts a flow diagram illustrating a communication from the customer 110 to the supplier 140. As previously discussed, the customer 110 places an order with the outlet 120, which typically occurs over the Internet or other distributed network. FIG. 3 illustrates three customers 110, each in communication with an outlet 120, but not necessarily the same outlet.

The outlets 120 communicate with the provider, 130 represented in FIG. 3 by the dashed line. Messages to the provider 130 are received by the communication layer 132, preferably as TCP/IP messages. The communication layer 132 can also store messages in appropriate folders which are monitored for new messages by the translation layer 134. Thus, messages can be sent via Hyper-Text Transfer Protocol (HTTP), File Transfer Protocol (FTP), or as Post or Get parameters of Common Gateway Interface (CGI) messages.

The received files and messages are passed to the translation layer 134 which parses the incoming files/messages to extract relevant information. Messages can be in any standardized or proprietary format provided that the translation layer is programmed to handle that format. For example, outlets 120 can use eXtensible Markup Language (XML), Electronic Data Interchange (EDI), flat files, or customized CGI messages. The translation layer 134 is further capable of translating outgoing messages into the format preferred by the receiving party (i.e., the supplier 140 or the outlet 120). In this manner, the provider 130 can communicate with many different parties in various standard or proprietary formats.

The data parsed from the messages at the translation layer 134 is passed to the application layer 136. Generally, all communication to and from the provider 130 is stored in the database 138 to create an auditable and complete record of each transaction, and the relevant data concerning the parties involved. The application layer 136 includes computer code executing in a processor and configured so as to analyze the data and perform the appropriate step outlined in process 200. The computer code can be within a program, a module, an object or other conventional software form. The translation layer 134 then receives the new outgoing data message and translates it into a format associated with the message recipient. The formatted message is then passed to the communication layer 132 which transmits it to either the supplier 140 or outlet 120.

The application layer 136 utilizes and maintains the information stored in the database 138. In one embodiment, the database 138 is a SQL database employing a database schema including tables for purchase orders, shipping notices, invoices, agreements, products, product outlets, product suppliers, and inventory. Preferably, the database is organized about three cross-referential sets of tables. Specifically, the database includes a set of product tables, a set of trading partner tables, and a set of messaging tables.

The product tables can store various information about the products supplied by the suppliers 140 and offered for sale by the outlets 120. For example, the product table can include a provider product ID that can be used to cross reference supplier-product-IDs and outlet-product-IDs. Additionally, marketing messages, labels, country of origin, manufacturer information, and other identifying information can be stored in the product tables of the database 138. This information can be provided to outlets 120 selectively as determined by further control information maintained in the database 138. Furthermore, the inventory count of each product also can be stored in the product tables.

Sales criteria, such as rules regarding required profit margins or quantity limits for specific products, can be stored in the product tables. These criteria can be associated with specific products or entire product categories. Alternatively, criteria for a particular outlet 120 or supplier 140 are preferably stored in the trading partner tables.

The trading partner tables store information about the outlets 120 and suppliers 140. For a given supplier 140, the trading partner tables can include identity information, contact information, warehouse information, geographical information, supplied products, and supplied product prices. For a given outlet 120, the trading partner tables can include identity information, contact information, branding information, and other relevant information. The trading partner tables can also specify the preferred message communication format for each supplier 140 and outlet 120. Thus, when sending a message, the provider 130 can translate the message into the appropriate format by examining the destination of the message and looking up the preferred message format in the appropriate table.

In a further detail of the trading partner tables, a set of agreement tables can store information concerning the relationships between outlets 120 and suppliers 140. This relationship information can include price commitments on specific products that have been secured from specific suppliers 140 and the products selected by a specific outlet 120 to be made available for sale. The agreement tables can further store the information required to translate a supplier-product-ID to an outlet-product-ID by creating entries in an agreement-item table that identifies the supplier-product-ID, supplier-product-ID, and provider-product ID. Additionally, the trading partner tables can further store information sufficient to enable the provider to limit a particular outlet's access to a specific supplier's products, and vice-versa, thereby preventing specific outlets 120 from viewing or including particle products from provider 130 among their offerings, and preventing specific suppliers 140 from receiving orders from a specific outlet 120.

Based on the agreements and information stored in the agreement tables, and preferably secured price commitments from suppliers 140, the provider price can be established (typically, at a price above the secured price commitment) and stored in the product tables. Additionally, after the provider price has been established, the provider price can be included in the information made available to outlets 120 regarding the products available for inclusion in their product offering.

Similarly, the database can store information regarding specific outlets 120 that permit the provider 130 to update the information displayable to a customer 110 on the outlet's website. Updates to information on the outlet's website can be pushed by the provider 130 to the outlet's web server. For example, the provider can store a password or encrypted key to negotiate access to protected webpages on the outlet's web server where information can be uploaded or modified. Alternatively, the outlet 120 can request updates from the provider 130 through an exchange of messages to synchronize the outlet's product offerings with the provider's database of available products, or the outlet 120 can request a new catalog of available products from the provider 130.

The messaging tables can coordinate and maintain a record of all communication between an outlet and the provider, and the provider and the supplier. The messaging tables can be use to create a record of all transactions and track a transaction's progress. Additionally, trading agreements and negotiations, as well as inventory updates, can also be stored in the messaging tables.

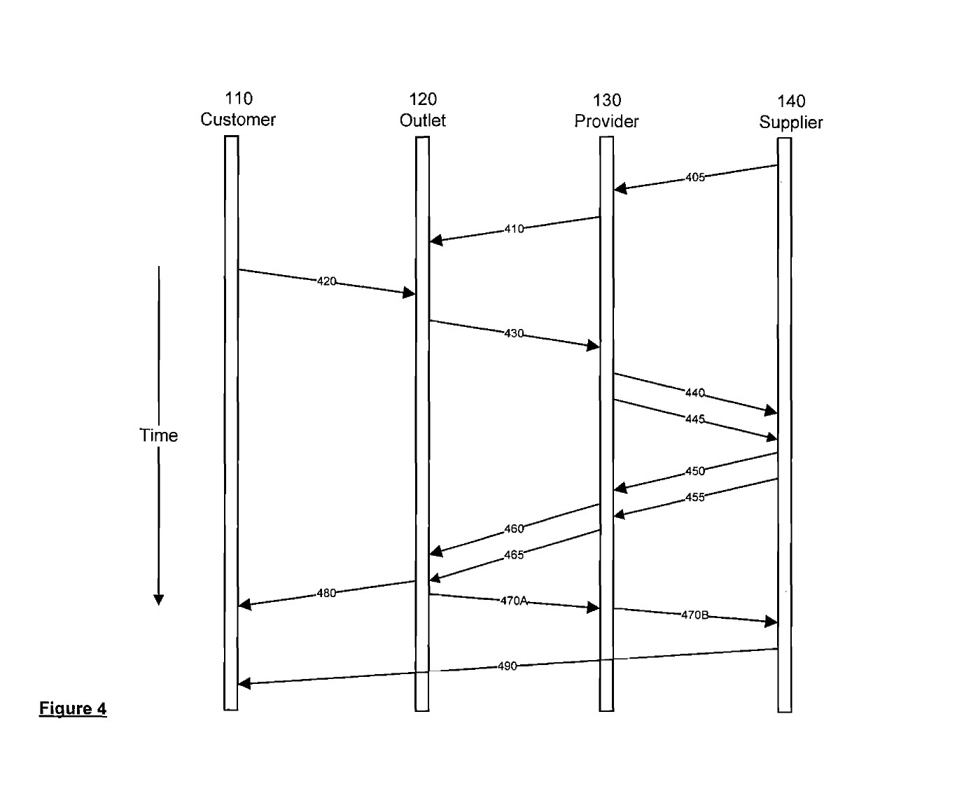

FIG. 4 depicts a flow messaging diagram of a transaction in accordance an embodiment of the present invention, and illustrates the cascade of messages between parties to complete the e-commerce transaction. The passage of time proceeds in the direction indicated by the time-arrow. Each party to the transaction is represented by a shaded vertical bar, and each arrow between the vertical bars represents a message sent by the party from which the arrow originates and received by the party indicated by the arrowhead.

Prior to a purchase by a customer 110, the supplier 140 transmits price commitments for specific products at message 405. Encapsulating the step of securing price commitments in one message 405 oversimplifies the process, because, in practice, the provider 130 and the supplier 140 negotiate a price commitment over the course of several messages and perhaps business meetings. Message 405 can also transmit the supplier's inventory of a product to the provider 130. Once the provider 130 has secured a selection of inventory from suppliers 140, and potentially secured price commitments and inventory levels, the provider 130 makes available to the outlet 120 a selection of inventory for inclusion in their product offering at 410. The product information, provider price, and inventory count can be pushed to subscribing outlets 120, or alternatively, the outlet 120 can request the information (not shown) and the provider 130 can supply the selection in response. Typically, the outlet 120 will select among various provider offerings and include a subset of them on its website.

The customer 110 upon reviewing the offerings of the outlet 120, places an order 420 for a product that is not held in inventory by the outlet 120 but is instead one of the offerings made available by the provider. The purchase order includes an identification of the product and a shipping address for the customer. The outlet 120 transmits a first purchase order 430 specifying the product, cost, shipping address, and outlet 120 identification to the provider 130.

The provider 130 receives the first purchase order 430 at communication layer 132, translates it at layer 134, and then passes the information to application layer 136, where the provider 130 preferably searches for suppliers 140 matching specific criteria at step 230. Preferably, once a list of suitable suppliers 140 has been determined, a supplier 140 is selected at step 240. A second purchase order can be generated and translated into the selected supplier's preferred message format by looking up the preferred format in the database 138 and translating the message at translation layer 134. The message conveying the second purchase order 440 is then sent through communication layer 132 to supplier 140.

Preferably, the provider 130 also transmits the originating outlet's branding requirements 445 to the supplier 140. As discussed above, the branding requirements can be communicated to the supplier 140 as part of the e-commerce transaction or prior to the transaction when the provider establishes the supplier-provider relationship or to the supplier 140 through a different route or mechanism such as from the outlet itself.

The supplier 140 accepts the purchase order and transmits the acceptance 450 to the provider 130. In response, the provider 130 transmits acceptance 460 of the first purchase order. As discussed above, the provider 130 can accept the first purchase order at any point after receiving the purchase order 430. However, it is preferred that the provider 130 delay acceptance of the first purchase order until the supplier 140 has accepted the provider's second purchase order 460. Similarly, the outlet can transmit acceptance of the customer's purchase at message 480, and this optionally can be done before receiving an acceptance of the order from the provider 130.

The shipping tracking number is transmitted at 455 by the supplier 140 to the provider 130, which is relayed to the outlet 120 by message 465, with or without additional information from the provider such as the provider's invoice. Typically, the outlet 120 does not charge the credit card of the customer 110 until the outlet 120 confirms that the package has been shipped. The party billing the customer 110 is the outlet 120, thus further insinuating to the customer 110 that the goods are from the entity that was paid (i.e., the outlet). Furthermore, the customer only makes a single payment to the outlet 120, despite the involvement of the provider 130 and supplier 140. Payments between the other involved parties are not visible, nor are they of concern, to the customer 110.

Preferably, the provider 130 transmits payment 470B to the supplier 140 after it has received notification of the shipping tracking number 455 and received payment 470A from the outlet 120. As discussed above, payment to the supplier can be transmitted earlier in the transaction communications; however, it is preferable to delay payment to the supplier 140 until the provider 130 has determined the supplier has fulfilled the second purchase order.

Up to this point in the transaction, all messages have cascaded between parties having a direct relationship with one another. However, with respect to message 490, which corresponds to the shipment of the purchased product from the supplier 140 to the customer 110, there is no direct or prior relationship between the supplier and the customer based on the e-commerce transaction, and so the customer 110 will not be aware of that the package is originating with the supplier instead of the outlet 120. From the point of view of the customer 110, the package will appear to have been shipped by the outlet 120 because the packaging, the invoice, the shipping label, and the box all reflect the branding requirements of the outlet 120, in accordance with one aspect of the invention.

Thus, the outlet 120 has completed an e-commerce transaction with a customer 110 for a selected product that was not held in inventory by the outlet 120, by communicating with a provider 130 that aggregates suppliers 140 and the products offered by those suppliers 140, and contracting with the provider to have the selected product shipped directly to the customer 110 as though it were shipped directly from the outlet 120.

While the above discussion focuses on the processing of e-commerce transaction that is satisfied in an inventory-less manner, the principles of the present invention can be utilized in pre-commerce decisions. For example, not every outlet 120 has the technical expertise, employees, money, or desire to generate its own online storefront. Each item for sale typically has its own product listing which includes information concerning the product as well as the outlet-sale price. Thus, in accordance with another aspect of the present invention, the provider 130 can perform various aspects of pre-commerce decisions and assume the burdens associated with generating an online storefront.

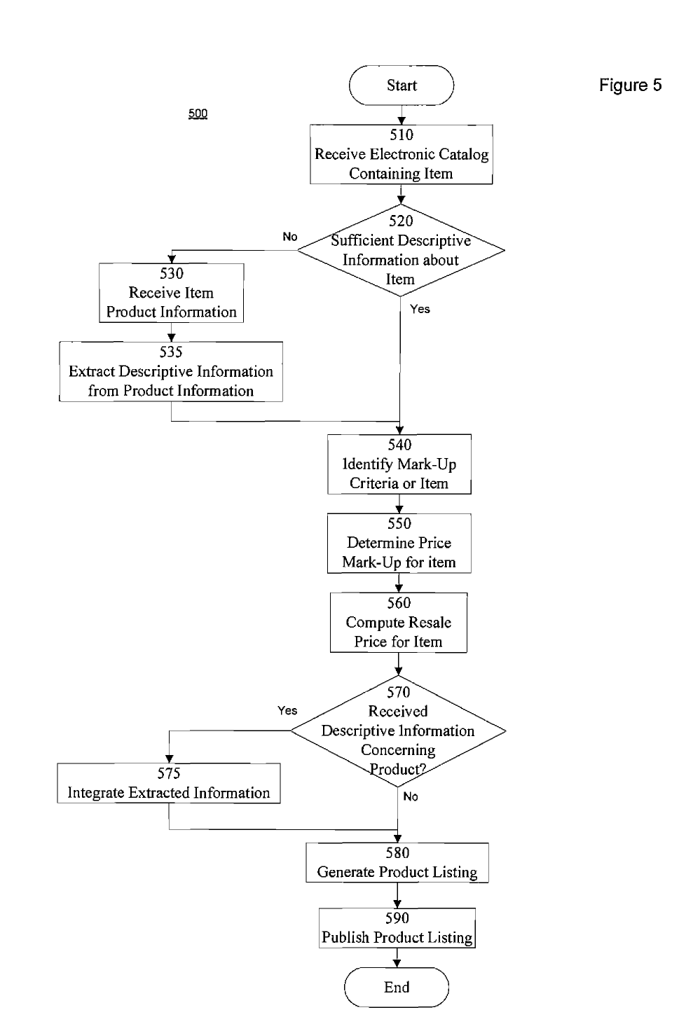

FIG. 5 illustrates a process 500 by which the provider 130 can reduce the overhead and decision making associated with running an online storefront. In particular, process 500 illustrates a way in which an outlet 120 can rapidly include new or different products in its storefront at customizable prices and/or margins.

At step 510, the provider 130 receives a catalog of items, preferably in an electronic format. The catalog can be transmitted as an XML file(s), a Hyper-Text Markup Language (“HTML”) file, or a flat-file. Optionally, the catalog can be received as a database file or as part of a database transaction which synchronizes a subset of the provider's database with a subset of the supplier's database. Broadly, receipt of the catalog includes the provider pulling its contents over a network connection.

The catalog includes items being offered for sale by the supplier 140 at a supplier-price. The supplier-price typically includes the mark-up introduced by the supplier 140. Further, the catalog can provide varying levels of detail concerning the item. For example, a catalog may include only a product number or identification (ID or a SKU) and the supplier price, or it can include many details such as a full description of the product, user reviews, and product specifications.

For each particular product, or for the catalog as a whole, the provider 130 can examine the descriptive information received from the supplier 140 to determine if sufficient descriptive information is available from the supplier to generate a product listing as shown at decision block 520. Descriptive information can include a written description, product specifications (e.g., weight, dimensions, or manufacturer), pictures, ratings, user description and/or reviews, and the date the item was first produced or released. Other information typically included in print or electronic catalogs can also be among the information used to generate the product listing.

Frequently, the catalog merely includes the item identification and a price. In such circumstances, the additional information can be gathered at step 530. Optionally, even if the supplier 140 has provided descriptive information, it can be supplemented by the procedure described herein. The information gathering process can include a request for further information from the supplier 140, a third-party, or the manufacturer of the product. For example, the provider 130 can request product information from a web-based product review site. Alternatively, the review site can publish information concerning products to which the provider 130 can subscribe and use as desired. In yet a further example, the provider 130 can scour or crawl a web-site and identify information relevant to the particular product. Information can also be gathered and aggregated from multiple sources. Once the product information is identified and retrieved, the information can be parsed to extract the descriptive information from the product information, as indicated at step 535. Rules can assist in extracting particular information (e.g., owners manual, images, etc.).

The provider 130 can also determine a mark-up for the item in the product listing at step 550. The mark-up can be determined based on one or more mark-up criteria which were previously identified at step 540 and described further below. Mark-up criteria can be specified, or provided, by the provider 130, the supplier 140, and the retailer/outlet 120 using standard computer network communications or through off-line communications, the results of which are subsequently entered into the provider's computer system.

By basing the mark-up determination on criteria received from the supplier 140, provider 130, or outlet 120, all parties to the transaction are afforded flexibility and control over the management of the price at which the item is offered. Criteria provided by the outlet 120 or supplier 140 to the provider 130 are preferably provided along with the catalog or prior to receiving the catalog at step 510. However, the supplier 140 or outlet criteria can be provided in a real-time (i.e., on a need-to-know) basis. That is, the provider 130 can actively request the criteria from the supplier 140 or outlet 120 when it is ready to compute the markup. In this manner, outlets and suppliers can continually adjust their mark-up criteria and see those adjustments incorporated into the price specified in the published product listing. Moreover, the price of the product listing can be calculated on a real-time basis and be based on real-time adjustments to the mark-up criteria. For example, the mark-up, price calculation, and retrieval of the mark-up criteria can be performed each time the product listing is called up for viewing by a customer. This allows merchants to react quickly to changes in demand, popularity, and inventory nearly immediately with a dynamically calculated pricing structure based on rules and market/supply conditions.

Mark-up criteria can be calculated in various ways and preferably includes several factors considered by the provider 130. For example, the provider 130 can set mark-ups as a percentage of the supplier price. The mark-up can include an absolute value added to the supplier price. The magnitude of the markup can include a consideration of the category of the product (e.g., movies, music, sports equipment, cooking supplies, etc.), such that each category is associated with a dollar or percentage mark-up. Similarly, the mark-up can take into consideration the identity of the supplier 140 of the product and the identity of the outlet/retailer to whom the product listing is being published. For example, suppliers and retailers can have an associated preference rating, and items offered by highly preferred suppliers and retailers can receive comparatively lower mark-ups than less preferred suppliers/retailers in order to promote an increased volume of sales for those suppliers and retailers. Additionally, if a particular retailer places additional restrictions on the provider 130 thereby increasing the costs associated with doing business through the retailer, the provider 130 may lower the preference rating of the retailer resulting in an increase in the mark-up of the price of the items published to that retailer. A combination of rules can be invoked in computing a price mark-up for any given outlet 120.

While the term mark-up is traditionally associated with an increase in cost, it should be noted that a “mark-up” encompasses any change to a price and thus can include negative values. A mark-up may be negative if an item is being sold as a loss-leader to increase traffic to the store (e.g., click-through traffic to the web-based storefront), or if the manufacturer or supplier 140 is offering a sales incentive such as market development funds, by which a retailer is paid to carry an item to increase its market presence.

Using the mark-up criteria, the mark-up price is determined at step 550. Since multiple criteria can be considered, the criteria can be weighted according to the retailer's preference. Further, the category or other metadata associated with the criteria can include a weighting and thereby influence the price mark-up. For example, a retailer that advertises the lowest prices on all DVDs may heavily weight the category criteria to ensure that the provider 130, as part of the pre-commerce process, computes a low price mark-up for all DVDs to be listed for sale by that particular supplier 140. After the determination of the price mark-up, the resale price of the item is computed at step 560, preferably by adding the price mark-up to the supplier price.

While FIG. 5 illustrates the identification of mark-up criteria at step 540, the determination of the price mark-up at step 550, and the computation of the resale price at step 560, as occurring after the retrieval of descriptive production information at step 530, (in situations in which further descriptive information is desired) it will be understood by one of ordinary skill in the art that the resale price computation and the acquisition of descriptive product information are order independent steps. The resale price computation at steps 540-560 need only be performed after the identification of descriptive product information if the supplier catalog does not provide sufficient information to analyze all mark-up criteria (e.g., if the category of the item is indeterminable from the catalog).

Prior to creating and publishing the product listing, the provider 130 preferably checks at decision 570 whether additional descriptive information has been received from a party other than the supplier 140. If additional information has been received, the extracted product information is integrated into the information included in the product listing at step 575. Information received from the supplier 140 can be used by itself, augmented, or replaced by the extracted information. How the information is integrated can be decided in several ways by investigating several factors, including the source of the third-party information, the source of the catalog listing and the information provided therewith, and the type and/or category of the information (e.g., product description, user rating, or product specifications). For example, the provider 130 can determine which third-party information sources provide reliable information on a category by category basis and determine which information to include based on that determination. Or, in a further example, if a particular supplier's catalog has a high level of detail, the provider 130 can decide to augment but not replace the descriptive information.

The product listing is then generated at step 580. The listing generation can include the creation of the provider's own catalog in a format that can be published by the supplier 140. Alternatively, the listing can be formatted as preferred by a particular outlet/retailer 120. If different retailers prefer differing formats, the product listing can be created and maintained so as to be deliverable in multiple formats. Preferably each version of the product listing is associated in the database with a common provider item record, but it can also be stored in multiple formats if desired.

The generated product listing is then published, at step 590, preferably in a manner that enables retailers to subscribe to the published product listings. Publication can include the distribution of a file, such as a flat file or database file. Alternatively, updates can be pushed over a network connection to a retailer, or made available on a networked server from which the retailer can pull the information, either periodically or in response to a notification from the provider 130 that the information on its server has been updated.

Optionally, the product listing can be published as an interactive product listing such as a web page. Thus, a retailer can create a store front by simply choosing which products it desires to offer for sale and including the associated published interactive web pages in its store front. For example, a retailer can visit the provider's website to view the available product listings. When the retailer accesses the provider's site, the provider 130 can identify or load the retailer's mark-up criteria to create a customized presentation of the available product listings. The retailer's mark-up criteria can be accessed in several ways. The mark-up criteria can be communicated in a cookie to the provider as part of the HyperText Transfer Protocol (HTTP) request. Alternatively, the mark-up criteria can be retrieved from a database or lookup table at the provider. If the retailer is not associated with a set of mark-up criteria, the provider can use default mark-up criteria or redirect the retailer to a form through which mark-up criteria can be specified. When the retailer views a particular product listing, the provider 130 can present the retailer with the price for which the provider 130 will sell the item to the retailer (i.e., a price that is calculated using the outlet's mark-up criteria and the provider's mark-up criteria), a suggested retail price, and/or the retailer's price (i.e., a price that is calculated using the outlet's mark-up criteria, the provider's mark-up criteria, and the retailer's mark-up criteria).

The provider 130 can concurrently receive and process requests from multiple retailers. Furthermore, the provider can apply the respective mark-up criteria of each retailer at the same time. By way of example, Retailer A can view a customized product listing for a particular product that includes a provider price of $14.50 and a retailer price of $19.00. At the same time, Retailer B can view a customized product listing for the same item which shows a provider price or $15.00 and a retailer price of $20.00. Thus, the provider 130 can customize product listings according to the mark-up criteria of the supplier 140, the provider 130, and the particular outlet/retailer 120, in response to access by the particular retailer. In yet a further aspect of the present invention, Retailer C, which is not associated with any mark-up criteria, can view a product listing of the item which shows a provider price of $15.50 and, optionally, a suggested retail price of $19.50. Thus, multiple retailers can view the same catalog item, but will be presented with different product information and pricing based on each retailer's respective mark-up criteria.

A retailer can thereby quickly create and establish an online storefront offering a wide range of products in an inventory-less manner, at customizable profit margins, and supplied from multiple sources, without incurring the overhead and expensive infrastructure required to warehouse products and create an online presence. While the above discussion has focused on a transaction involving three parties: the supplier 140, the provider 130, and the outlet/retailer, it would be understood by one of ordinary skill in the art that a single company can have multiple roles. For example, the provider 130, in addition to acting as the provider 130, can create its own store front and act as an outlet 120.

While the invention has been described in connection with a certain embodiment thereof, the invention is not limited to the described embodiments but rather is more broadly defined by the recitations in the claims below and equivalents thereof.

We claim:

1. A method in support of pre-commerce decision making for generating a product listing through which an item is offered for sale, comprising the steps of:
receiving an electronic-catalog from a supplier, the electronic-catalog containing an item to be for sale by the supplier at a predetermined supplier-price;
determining a price markup for the item based on a markup-criteria;
automatically computing a resale price for the item that includes the supplier-price plus the price markup;
generating the product listing for the item being offered for sale at the resale price;
publishing the product listing.

2. The method of claim 1, including the additional steps of:
receiving product information concerning the item;
extracting descriptive information from the product information concerning the item; and
integrating the extracted descriptive information into the product listing.

3. The method of claim 2, wherein the product information is received from a source other than the supplier.

4. The method of claim 1, wherein the product listing is published to a retailer, the method including the additional step of enabling customer acceptance of the item at the retail price through interaction with the product listing.

5. The method of claim 4, wherein the retailer is associated with a preferred publishing format, the method including the additional step of formatting the product listing in the retailer preferred publishing format prior to the publishing step.

6. The method of claim 4, including the additional step of determining a retailer preference rating, wherein the markup-criteria uses the retailer preference rating in computing the price markup.

7. The method of claim 4, wherein the markup-criteria uses retailer-specific criteria in computing the price markup.

8. The method of claim 1, wherein the markup-criteria uses the predetermined supplier-price in computing the price markup.

9. The method of claim 1, including the additional step of associating the item for sale within a category, wherein the markup-criteria uses the category of the item for sale in computing the price markup.

10. The method of claim 1, including the additional step of determining a supplier preference rating, wherein the markup-criteria uses the supplier preference rating in computing the price markup.

11. The method of claim 1, wherein the product listing includes a web-page.

12. The method of claim 1, including the additional step of subscribing to the electronic-catalog from the supplier.

13. The method of claim 1, wherein the determined price markup comprises a negative value.

14. A method in support of pre-commerce decision making to generate a product listing through which an item is offered for sale, and processing a purchase transaction for the item by a customer in an inventory-less manner, comprising the steps of:
receiving an electronic-catalog from a supplier, the electronic-catalog containing an item being offered for sale by the supplier at a predetermined supplier-price;
determining a price markup the item based on a markup-criteria;
automatically computing a resale price for the item that includes the supplier-price plus the price markup;
generating an interactive listing for the item at the resale price;
publishing to a retailer the interactive listing;
receiving an order from the retailer for the item included in the interactive listing in response to a purchase by the customer at the retailer;
charging the retailer the resale price for the item;
obtaining an address of the customer;
purchasing the item from the supplier at the supplier-cost; and
instructing the supplier to ship the product to the address of the customer.
